(19) United States
(12) Patent Application Publication
(10) Pub. No.: US 2009/0234732 A1
(43) Pub. Date: Sep. 17, 2009

(54) APPARATUS, SYSTEM AND METHOD FOR SELECTIVELY RECEIVING ADVERTISING RELATED CONTENT

(76) Inventors: Ilan ZORMAN, Pala Alto, CA (US); Ziv HAPARNAS, San Francisco, CA (US); Dror BUKAI, Caesarea (IL)

Correspondence Address: Pearl Cohen Zedek Latzer, LLP, 1500 Broadway, 12th Floor, New York, NY, 10036, US

(21) Appl. No.: 12/048,898

(22) Filed: Mar. 14, 2008

(51) Int. Cl. G06Q 30/00; G06F 15/16

(52) U.S. Cl. 705/14; 709/203

(57) ABSTRACT

A system and method for providing content and advertisements to a user. Embodiments of the invention may enable an advertiser to provide preferred content and advertisements and to avoid providing undesirable content and advertisements by storing content selection parameters on a customer computer or an advertisement selection computer. The selection parameters may be used to select content and advertisements to be provided to a user. A user identification parameter may be used to locate associated selection parameters. Other embodiments are described and claimed.

### BACKGROUND OF THE INVENTION

Advertisements have become and are likely to remain a major driving economic force behind the Internet. Users browsing the Internet today are exposed to various types of advertisement displayed or otherwise provided by Internet web sites or other entities. Advertisements may vary in type, content, formats and/or other aspects. Various algorithms, methods and/or systems today attempt to select advertisements that best suit a specific user or user groups.

Advertisements are generally considered as an acceptable, at times desirable, part of media such as the Internet, television and radio broadcasting. Typically, advertisements are considered non-intrusive and non-offensive by a majority of users. However, some advertisements may be annoying, offending or otherwise unwanted and/or unacceptable by specific users or users groups, which may result in a negative impact on the publisher of the ads or the advertiser.

### SUMMARY OF EMBODIMENTS OF THE INVENTION

It may be in the interest of the publisher, the advertiser and the viewer or consumer of advertisements to control the presentation of advertisements on an individual user level. There is therefore a need for a system and/or method to enable a user or a consumer of advertisements to influence, affect or otherwise control the selection of advertisements presented.

Embodiments of the present invention provide a system and method for controlling presentation of advertising content to a user. Embodiments of the invention may enable a user to configure a content and/or advertisement selection process. According to embodiments of the invention, a user is provided with the ability to select or opt-in to certain desirable advertisement selection or presentation criteria and/or to block or opt-out of based on undesirable advertisement selection or presentation criteria.

According to some embodiments of the invention, this selection or deselection preferences of the user may be input from the advertisement itself, for example, a check box in a banner advertisement. For example, an advertisement may include a small icon, for example, an “X” that may allow a user to easily opt-out of an advertisement, or another clickable icon to present selection/deselection parameters to a user to record the user preferences of content and/or advertisements to be provided to the user.

According to embodiments of the invention, an identification parameter may be stored on a user's computer and may be used to locate the relevant selection parameters. Other parameters may be controlled, such as category of product advertised, type of advertisement, day of the week or time of day of advertisement presentation, etc.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows a schematic high-level diagram of exemplary components according to embodiments of the present invention;

FIG. 2 shows a schematic time-event flowchart according to some embodiments of the invention;

FIG. 3 shows a schematic time-event flowchart according to some embodiments of the invention; and

FIG. 4 shows a schematic time-event flowchart according to some embodiments of the invention.

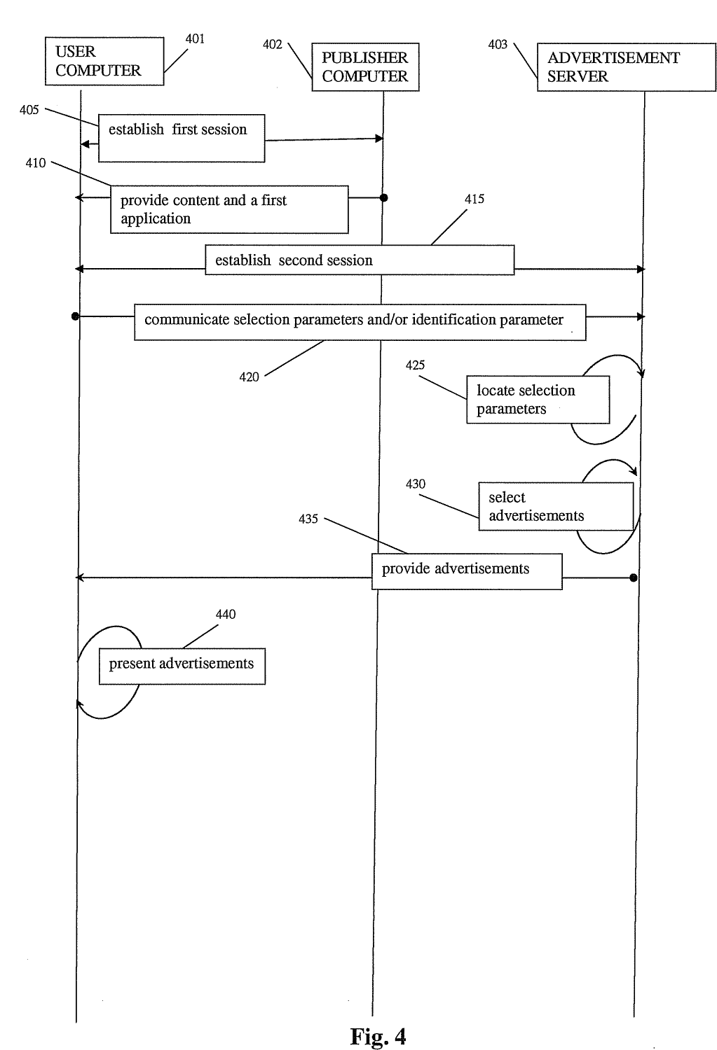

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

The term “opt-out” used in this patent application specification should be expansively and broadly construed to include any blocking, avoiding or otherwise preventing a serving, reception and/or acceptance of digital content. The terms opt-out, blocking, preventing or avoiding may be used interchangeably in this patent application specification.

The term “opt-in” used in this patent application specification should be expansively and broadly construed to include any allowing, permitting or otherwise enabling a serving, reception and/or acceptance of digital content. The terms opt-in, allowing, permitting or enabling may be used interchangeably in this patent application specification.

The term “computer” or “computing device” may be a personal computer, a desktop computer, a mobile computer, a laptop computer, a set-top box, a notebook computer, a workstation, a server computer, a tablet computer, a network appliance, personal digital assistant (PDA), mobile phone, or any other suitable computing device. Typically, a computer includes or is operatively connected to means for connecting the computer to another computer via a network, for example, the Internet.

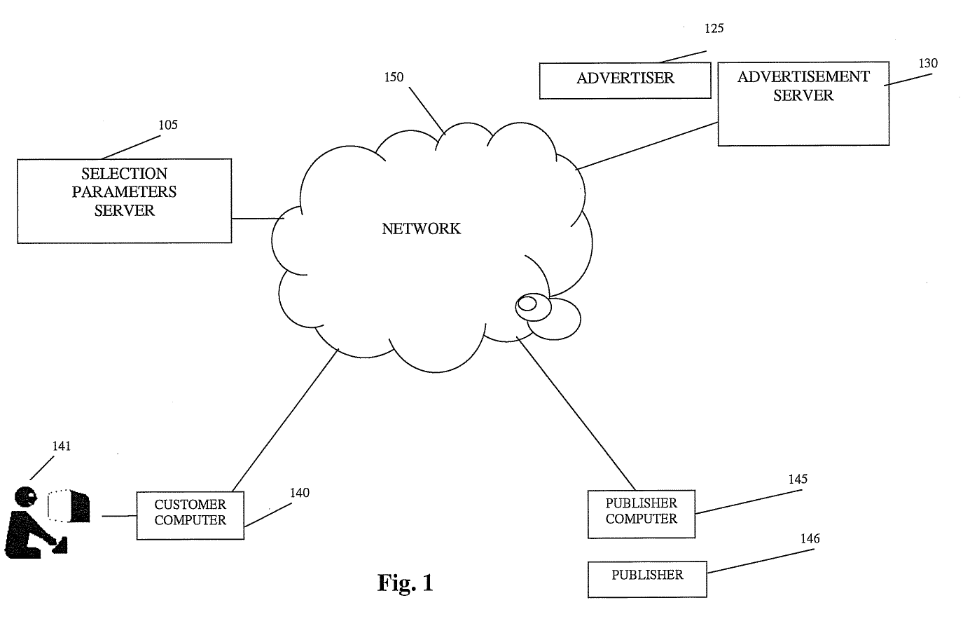

Reference is made to FIG. 1 showing an exemplary schematic high-level diagram of a computing environment according to embodiments of the present invention. According to embodiments of the invention, user or customer computer 140 may be any suitable computing device, for example, a computer as described above. According to embodiments of the invention, customer computer 140 may be owned by user 141 or may be owned by an organization. According to embodiments of the invention, user 141 may be any human who operates customer computer 140. According to embodiments of the invention, customer computer 140 may be operated by more than one users such as user 141. For example, customer computer 140 may be used and/or operated by two or more family members in a home or by two or more employees in an office or other work environment.

According to embodiments of the invention, publisher computer 145 may be any computer such as described above, capable of establishing a connection over a network. According to embodiments of the invention, publisher computer 145 may perform services for and/or on behalf of publisher 146. According to embodiments of the invention, publisher 146 may be any person or entity owning and/or operating a publishing infrastructure such as an internet web site, television, an IPTV network or channel, an advertisement spot within a web site, an advertisement spot on an IPTV channel, an advertisement spot on television, etc. According to embodiments of the invention, publisher computer 145 may host one or more internet web sites or any other media publishing network such as TV stations or ad spot feeds, etc. Such publishing infrastructure may be maintained, managed and/or operated by publisher 146. According to embodiments of the invention, publisher computer 145 may be located at any suitable location, for example, a data center, possibly owned by a hosting company, or computer 145 may be located on premises belonging to publisher 146. According to embodiments of the invention, publisher computer 145 may be located in any suitable physical location where network connectivity is available. It will be recognized that according to embodiments of the invention, publisher computer 145 may be a plurality of computers or servers operating together.

According to embodiments of the invention, advertiser 125 may be any person, body or entity such as, but not limited to, a commercial or other organization, an institution or agency that advertises a product, service or any other merchandise. According to embodiments of the invention, advertiser 125 may not be limited to commercial aspects of advertising. For example, advertiser 125 may be a government agency, an academic institution or a health care facility that needs and/or wants to inform various audiences or addressees of various aspects of their activities, or retrieve information from various groups or individuals. According to embodiments of the invention, advertisement server 130 may be a computer a computer as described above or any other suitable computing device. According to embodiments of the invention, advertisement computer 130 may be owned, operated and/or otherwise managed by an operator of an advertisement network and/or may be co-located. According to embodiments of the invention, advertiser 125 may use services provided by an operator of an advertisement network operating advertisement server 130 in order to advertise his merchandise or services to potential customers.

According to embodiments of the invention, network 150 may provide an infrastructure for computer communications. For example, network 150 may comprise all or a portions of a public switched telephone network (PSTN), a public or private data network, a local area network (LAN), a metropolitan area network (MAN), a wide area network (WAN), a global computer network such as the internet, a cable or satellite TV broadcasting network, a peer to peer network, a video broadcasting network, a wireline or wireless network, a local, regional, or global communication network, an enterprise intranet, other suitable communication links, or any combination of the preceding.

According to embodiments of the invention, selection parameters server 105 may be a computer, for example, as described above. According to embodiments of the invention, selection parameters server 105 may store user selection parameters. For example, selection parameters server 105 may store information and/or parameters that may be used in order to select advertisements or content to be provided to a user such as user 141. According to embodiments of the invention, selection parameters may denote or indicate various content types or content keywords as undesirable by a specific user while indicating other content or advertisements types, keywords, classes or categories as desirable. For example, a set of selection parameters associated with a specific user may reflect such users willing to be provided with advertisements pertaining to the show business, and money market but avoid advertisements associated with the computers and networking industry. Other advertisement types may relate to the type of advertisement, e.g., pop-up, video ad, audio ad, an interactive game, a mouse-tracking advertisement, etc.

According to embodiments of the invention, selection parameters stored by selection parameters server 105 may further comprise of rules, policies and/or any other applicable information that may be used by a process, procedure, computational procedure, algorithm or system for selecting content and/or advertisements. For example, such rules may reflect a user's preference to be provided with advertisements for restaurants during a specific time window, e.g., 06:00 PM through 09:00 PM, possibly on specific days of the week, e.g., over the weekend. According to embodiments of the invention, policies that may be enforced using selection parameters may associate content and advertisements. For example, a policy may dictate that specific advertisements may or may not be provided while specific content is being provided or presented. For example, advertisements for birth control may not be presented when an internet site providing online games for kids is being interacted with.

According to embodiments of the invention, selection parameters server 105 may store a plurality of selection parameters sets that may be associated with a respective plurality of users. According to embodiments of the invention, selection parameters server 105 may locate selection parameters pertaining to a specific users by utilizing an identification parameter. Such identification parameter may be a unique sequence of characters, e.g., alphanumeric letters or numbers or any other information that may unambiguously identify a specific user. For example, a web cookie produced by a web server may be used or may comprise such identification parameter. According to embodiments of the invention, selection parameters server 105 may store selection parameters pertaining to a specific users in association with such identification parameter and may further locate such selection parameters by utilizing the associated identification parameter. According to embodiments of the invention, selection parameters server 105 may provide upon request selection parameters of a user. According to embodiments of the invention, a request may comprise an identification parameter as described above, e.g. a cookie.

According to embodiments of the invention, selection parameters server 105 and/or functionalities performed by selection parameters server 105 as described above may be embedded in or otherwise incorporated into advertisement server 130. For example, possibly in addition to serving advertisements, advertisement server 130 may further perform sum or all of the functionalities described above with reference to selection parameters server 105. e.g., store, provide and/or use selection parameters as described above. It will be recognized that embodiments of the invention are not limited or otherwise restricted to any number of computers or servers such as customer computer 140, publisher computer 145, advertisement server 130, or selection parameters server 105 nor are embodiments of the invention limited or otherwise restricted to any number of users such as user 141, advertisers such as advertiser 125 or publishers such as publisher 146.

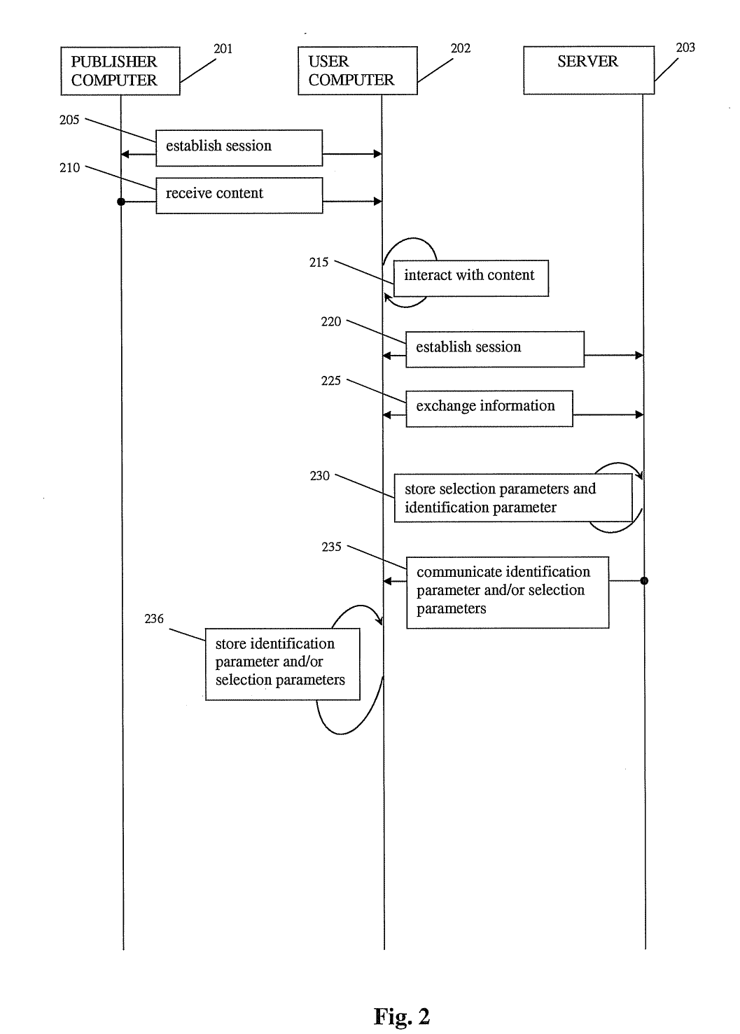

Reference is made to FIG. 2 depicting a schematic time-event flow according to embodiments of the invention. Publisher computer 201 may be a computer similar to publisher computer 145, user computer 202 may be similar to customer computer 140. Selection parameters server 203 may be a computing device similar to advertisement server 130 or selection parameters server 105. According to embodiments of the invention, server 203 may perform, implement, execute and/or implement functionalities described with regards to advertisement server 130 and/or selection parameters server 105. For example, server 203 may store, provide and use selection parameters and may further provide advertisements and/or content, for example, to user computer 202.

According to embodiments of the invention and as shown by block 205, a connection or session may be established between user computer 202 and publisher computer 201. For example, a user may point an internet or web browser at an internet site hosted on publisher computer 201. According to embodiments of the invention and as shown by block 210, the session established as shown by block 205 may comprise providing of content to user computer 202 by and/or from publisher computer 201. According to embodiments of the invention, the content provided may be any applicable content, for example, any content that may be provided by an internet or web site. According to embodiments of the invention, the content exchanged as shown by block 210 may comprise any digital content including applications, scripts, hypertext links, or programs. Content exchanged or provided as shown by block 210 may further include advertisements. According to embodiments of the invention, such advertisements may comprise, include or be otherwise associated with applications, scripts, hypertext links, or programs.

According to embodiments of the invention and as shown by block 215, the flow may include an interaction with provided content. For example, user 141 may interact with content provided by publisher computer 145. According to embodiments of the invention such interaction may be associated with presented advertisements. For example, advertising banners may be included or otherwise associated a web page presented to a user. Such banners may additionally be interactive. In some embodiments of the invention, the interaction may take the form of allowing a user to configure a content and/or advertisement selection process from the advertisement itself. For example, the selection or deselection preferences of the user may be input using a check box in a banner advertisement. For example, an advertisement may include a small icon, for example, an “X” that may allow a user to easily opt-out of an advertisement, or another clickable icon to present selection/deselection parameters to a user to record the user preferences of content and/or advertisements to be provided to the user.

According to embodiments of the invention, an interaction with provided content or advertisement may cause a session to be established between user computer 202 and server 203 as shown by block 220. For example, an advertisement banner may include code such as java code, that when activated, for example by clicking an associated graphical interface, may causes such session to be established.

According to embodiments of the invention and as shown by block 225, information may be exchanged over the session established as shown by block 220. According to embodiments of the invention, a user may be provided with an option to rate, approve, disapprove, opt-in, opt-out, or otherwise provide server 203 with feedback regarding content and/or advertisements. For example, according to some embodiments of the invention, an application executing on server 203 may provide a user such as user 141 with an ability to configure a content and/or advertisement selection process, procedure, algorithm, parameters, and/or any applicable aspects associated with content and/or advertisement selection. For example, a web page served to user 141 may enable user 141 to block or otherwise avoid reception of various types of content and/or advertisements by checking check boxes. According to embodiments of the invention, a user may block advertisements pertaining to a specific industry, market, social aspects or any other applicable aspects of economy, and/or any applicable topic and/or discipline. e.g., housing, money market, vehicles, consumer products, academics, politics or sports.

According to embodiments of the invention, a user may be able to select content and/or advertisements he or she wishes to accept, receive or otherwise be provided with. For example, a user may select to receive more advertisements for toys and less advertisements for cars. According to embodiments of the invention, any applicable aspects of content and/or advertisements reception, serving or providing may be configurable by a user. According to embodiments of the invention, advertisements from a specific advertiser may be blocked or allowed, or advertisements from a specific category and/or channel may be blocked or allowed. Alternatively, advertisements containing specific words, text strings or phrases may be blocked or opt-out. For example, a married couple may wish to block advertisements of the dating industry while a single person may allow them. According to embodiments of the invention, a user may block or opt-out all advertisements, namely, choose to be provided with no advertisements. According to embodiments of the invention, any other applicable information that may further be used by a content and/or advertisements selection process or entity may be provided by a user as shown by block 225. For example, a user may provide information such as age, gender, location (e.g., address), hobbies, fields of interest or any other applicable information or parameters. According to embodiments of the invention, complex selection rules may be configured by a user as part of the information exchanged as shown by block 225. For example, a user may allow or opt-in specific content or advertisement types or categories during specific hours of a day or days of the week, while block or opt-out these or other content and/or advertisements categories or types during other hours or days. According to embodiments of the invention, any applicable combination of selection criteria may be opt-in or opt-out by a user, e.g., block advertisements of a specific nature from a specific advertiser during selected hours or days of the week.

According to embodiments of the invention and as shown by block 230, the flow may include storing user selection parameters, preferences or choices regarding content and/or advertisements. For example, selection parameters server 105 shown in FIG. 1 may store such parameters. Although not shown, according to embodiments of the invention, such selection parameters may further be stored on a user computer such as computer 140 and/or a publisher computer such as computer 145. For example, selection parameters may be communicated by selection parameters server 105 to publisher computer 140 and/or user computer 145. According to embodiments of the invention, selection parameters server 105 may further communicate a computed identification parameter to publisher computer 140 and/or user computer 145. Such identification parameter may be used to associate selection parameters with a specific user or computing device.

According to embodiments of the invention and as shown by block 230, the flow may include storing an identification parameter. According to embodiments of the invention, such identification parameter may be a web cookie. For example, server 105 may compute an identification parameter associated with a specific user, associate such identification parameter with the specific user and further store such identification parameter. According to embodiments of the invention, server 105 may be configured such that when provided with such identification parameter it may locate associated selection parameters. For example, provided with an identification parameter associated with user 141, server 105 may locate, provide, or otherwise use content and/or advertisement selection parameters that were provided by user 141 or otherwise obtained.

According to embodiments of the invention and as shown by block 235, the flow may include communicating the identification parameter and/or content and/or advertisement selection parameters from server 203 to user computer 202. The flow may further include, as shown by block 236, storing of such identification parameter and/or content and/or advertisement selection parameters on computer 202. According to embodiments of the invention, selection parameters communicated as shown by block 235 may be associated with a cookie, for example, selection parameters may be embedded in or otherwise incorporated into a web cookie. Accordingly, storing the selection parameters as shown by block 236 may comprise installing a cookie on user computer 202. According to embodiments of the invention, such cookie, containing selection parameters may be retrieved, possibly over a subsequent session, by server 203. For example, server 203 may be an advertisement server that may retrieve a cookie containing the selection parameters and further use the selection parameters to select content and/or advertisements to be provided to user computer 202.

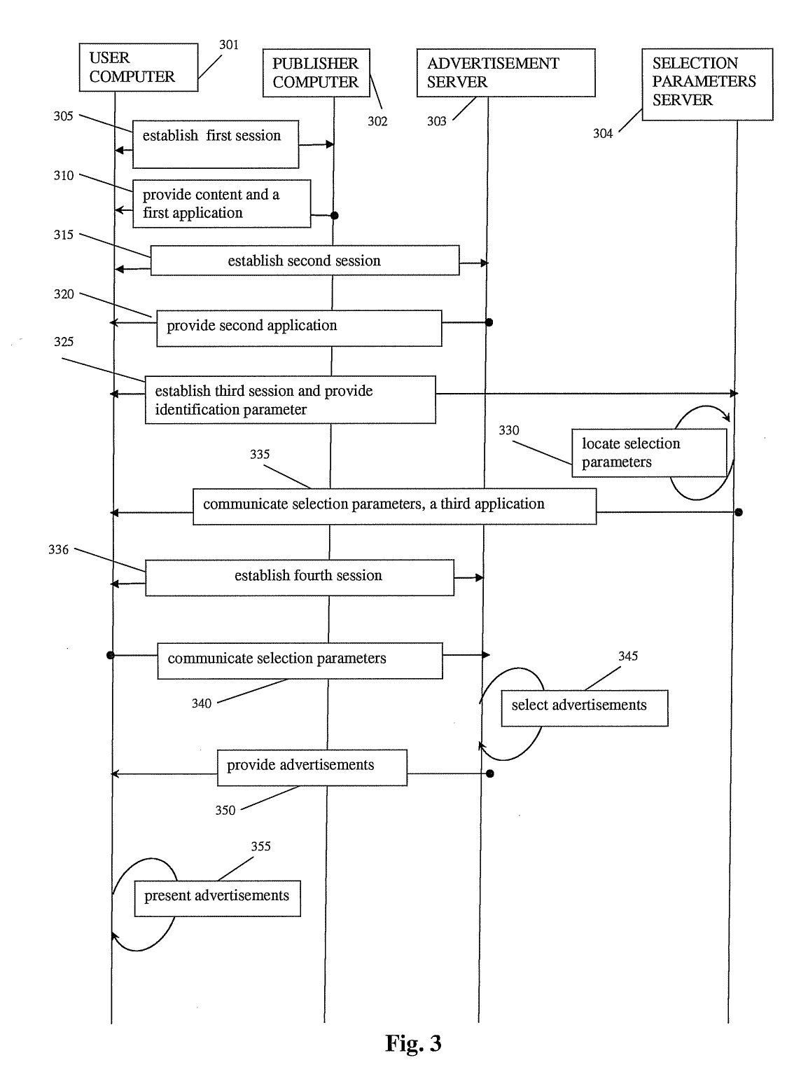

Reference is made to FIG. 3 depicting a time-event flow according to embodiments of the invention. User computer 301 may be a computer similar to computer 140, publisher computer 302 may be a computer similar to publisher computer 145, advertisement server 303 may be a computer similar to advertisement server 130 and selection parameters server 304 may be a computer similar to selection parameters server 105.

According to embodiments of the invention and as shown by block 305, a first connection or session may be established between user computer 301 and publisher computer 302. For example, such first session may be established as a result of a user pointing a web browser at an internet site hosted on publisher computer 302. According to embodiments of the invention and as shown by block 310, possibly in addition to content provided (not shown), a first application may be communicated from publisher computer 302 to user computer 301. For example, a java application, code or script may be communicated. According to embodiments of the invention, the application communicated as shown by block 310 may be executed on user computer 310, for example, a browser provided with a java code or application may execute such code. According to embodiments of the invention and as shown by block 315, a second connection or session may be established between user computer 301 and advertisement server 303. According to embodiments of the invention, such second session may be established as a result of executing the application provided as shown by block 310. For example, the application provided by publisher computer 302 as shown by block 310 may be configured, or provided with parameters that may enable it to establish the second session as shown by block 315. According to embodiments of the invention, by properly configuring the application provided as shown by block 310, a user may cause user computer 301 to establish the second session with any one or more advertisement servers such as advertisement server 303 or any other computer.

According to embodiments of the invention and as shown by block 320, advertisement server 303 may provide cause user computer 301 with a second application. According to embodiments of the invention, such second application may be similar to the first application provided as shown by block 310 in that it too, when executed, may establish a session over a network with a remote computer. According to embodiments of the invention and as shown by block 325, a third session may be established between user computer 301 and selection parameters server 304. According to embodiments of the invention, the second application provided as shown by block 320 may be configured to establish such third session when executed. Accordingly, the third session may be established as a result of a web browser executing the second application. According to embodiments of the invention and as shown by block 325, an identification parameter may be communicated from user computer 301 to selection parameters server 304. For example, such identification parameter may be a cookie installed on user computer 301 as described with reference to block 236 in FIG. 2. According to embodiments of the invention, a cookie associated with selection parameters server 304 previously installed on user computer 301 may be retrieved by selection parameters server 304. Accordingly, such cookie may be communicated to selection parameters server 304 from user computer 301 as shown by block 325.

According to embodiments of the invention and as shown by block 330, selection parameters may be located. According to embodiments of the invention, selection parameters server 304 may use an identification parameter or a cookie provided by user computer 301 as shown by block 325 in order to locate selection parameters associated with user computer 301 or with a specific user operating user computer 301. According to embodiments of the invention and as described above, selection parameters server 304 may store selection parameters pertaining to a specific computer or user with association to an identification parameter or cookie. For example, the identification parameter may be used as a search key for locating a specific entry in a database or other information repository storing selection parameters.

According to embodiments of the invention and as shown by block 335, selection parameters located as described above may be communicated from selection parameters server 304 to user computer 301. According to embodiments of the invention a third application, e.g., java code or script may be provided by selection parameters server 304 to user computer 301 as shown by block 335. Such application may be configured to establish a session between user computer 301 and advertisement server 303 as shown by block 336. According to embodiments of the invention, the identification parameter provided to selection parameters server 304 as shown by block 325 may be associated or may pertain to a computer, e.g., user computer 301 or to a specific user, e.g., a specific user operating user computer 310. For example, a cookie communicated as shown by block 325 may be associated with a specific user operating user computer 301 or may alternatively by associated with user computer 301 and accordingly communicated as shown regardless of the specific user operating user computer 301. According to embodiments of the invention and as shown by block 340, sum or all selection parameters communicated from selection parameters server 304 to user computer 301 as shown by block 335 may be communicated from user computer 301 to advertisement server 303. According to embodiments of the invention, such communication may be performed over a session established as shown by block 336.

According to embodiments of the invention, any number of advertisement servers such as advertisement server 303 may be associated with a number of publisher computers such as publisher computer 302. Accordingly, any one of such plurality of advertisement servers may server content and/or advertisements to user computer 301 as a result of an interaction with publisher computer 302. According to embodiments of the invention, a configuration as described above, whereby a selection parameters server such as server 304 may provide selection parameters associated with a specific user and/or computer may enable consistent advertisement and/or content selection even in cases where a large number of publisher computers, advertisement servers or even advertisement networks are involved.

Although not shown, according to embodiments of the invention, advertisement server 303 may store selection parameters received as shown by block 340. According to embodiments of the invention, advertisement server 303 may further produce an identification parameter associated with user computer 301 or with a specific user operating user computer 301. According to embodiments of the invention, such identification parameter may be a cookie. According to embodiments of the invention, advertisement server 303 may store received selection parameters and a cookie or identification parameter such that when provided with the cookie or identification parameter stored selection parameters may be located. For example, the identification parameter or cookie may be used as a search key associated with a database or other information repository, accordingly, the identification parameter or cookie may be used to extract the selection parameters from such database or information repository.

According to embodiments of the invention, advertisement server 303 may further communicate the identification parameter or cookie to user computer 301 and further cause the identification parameter or cookie to be stored or otherwise installed on user computer 301. According to embodiments of the invention, a cookie installed as described above may be retrieved, possibly over a future session, by advertisement server 303 and further used to retrieve stored selection parameters that may in turn be used to select advertisements or content to be provided to computer 301. According to embodiments of the invention, storage of selection parameters by advertisement server 303 as described above may be temporary. For example, advertisement server 303 may be configured to cache selection parameters for a predefined period of time. Such configuration may serve, for example, to improve performance and/or decrease network load. However, according to embodiments of the invention, a change or modification of selection parameters stored on selection parameters server 304 may cause such stored or cached selection parameters on advertisement server 303 to be deleted and/or replaced.

According to embodiments of the invention and as shown by block 345, advertisements and/or content to be communicated to user computer 301 may be selected. According to embodiments of the invention, advertisement server 303 may use selection parameters provided to it, for example as shown by block 340, to select advertisements and/or content to be provided to user computer 301. According to embodiments of the invention and as described above, selection parameters may provide advertisement server 303 with information that may be used in order to determine whether various content and/or advertisements may or may not be provided to user computer 301 or to a specific user operating user computer 301.

According to embodiments of the invention and as shown by block 350 content and/or advertisements may be provided. According to embodiments of the invention, advertisements and/or content selected as shown by block 345 may be communicated from advertisement server 303 to user computer 301. According to embodiments of the invention and as shown by block 355, advertisements and/or content communicated as shown by block 350 may be presented or otherwise provided to a user by user computer 301. It will be recognized that various other flows may be possible according to embodiments of the invention. For example, enabling or configuring applications such as the first application provided as shown by block 310 and the second application provided as shown by block 320 may enable embodiments of the invention to establish fewer sessions and/or execute fewer and/or other applications.

According to embodiments of the invention, an alternative flow may comprise steps similar to those shown by blocks 305, 310 and 315. However, according to embodiments of the invention, a cookie containing selection parameters, possibly installed as shown by block 236 may be communicated over the session established as shown by block 315. According to embodiments of the invention, an alternative flow as described above may proceed as shown by blocks 340, 345, 350 and 355. According to embodiments of the invention, communicating selection parameters as shown by block 340 may comprise retrieving a cookie containing such selection parameters as described above. Accordingly, such selection parameters may be used for selecting content and/or advertisements as shown by block 345. The alternative flow may further comprise communicating content and/or advertisements as shown by block 350 and presenting content or advertisements to a user as shown by block 355. Note that an alternative flow as described above may bypass selection parameters server 304. in case an appropriate cookie is discovered on user computer 301.

Although not shown, according to embodiments of the invention, possibly in addition to providing advertisements as shown by block 350, advertisement server 303 may communicate to user computer 301 some or all of the selection parameters received from user computer as shown by block 340. According to embodiments of the invention, server 303 may associate the selection parameters with a cookie, for example, the selection parameters may be embedded in a cookie. According to embodiments of the invention, server 303 may retrieve such communicated selection parameters, possibly over a subsequent session, for example by retrieving a cookie containing the selection parameters as described, and may further use selection parameters thus obtained in order to select content and/or advertisements to be provided to user computer 301.

receiving selection parameters as shown by block 335, user computer may store such received selection parameters, for example, as shown by block 236 in FIG. 2. According to embodiments of the invention, such selection parameters may be accompanied by or incorporated in a web cookie. Such stored selection parameters may be used, possibly in conjunction with an identification parameter such as a cookie in subsequent session as will be described below. For example, user computer 301 may provide an advertisement server such as advertisement server 303 with stored selection parameters received as shown by block 335. An advertisement server may further use such provided selection parameters to select advertisements and/or content to be communicated to user computer 301.

According to embodiments of the invention, functionalities performed by selection parameters server 304 described above may be performed by an advertisement server such as advertisement server 303 or 130. Alternatively or additionally, such functionalities may be performed by a publisher's computer, e.g., publisher computer 145 or publisher computer 302. For example, selection parameters may be stored on a publisher computer or an advertisement server and may further be used to select content and/or advertisements to be provided to a user.

According to embodiments of the invention, possibly after content and/or advertisements selection parameters, policies and/or rules are stored as described above, a user may further configure, add, modify or otherwise manipulate selection parameters, policies, constraints and rules. For example, an advertisement presented to a user, e.g., as part of the content exchanged as shown by block 210 in FIG. 2 or block 310 in FIG. 3, may enable a user to interact with a content and/or advertisement selection process, e.g., configure a selection process executed by selection parameters server 105. According to embodiments of the invention, advertisements may comprise or be otherwise associated with code or applications such as java scripts or executable code. According to embodiments of the invention, code embedded in, or otherwise associated with advertisements may, possibly as a result of user interaction, establish a session with a server such as selection parameters server 304 or an advertisement server such as advertisement server 303. According to embodiments of the invention, such or other invoked application may further enable a user to configure, modify, alter or other wise maintain selection parameters associated with a serving of content and/or advertisements to the user or to an associated computer.

For example, an advertisement may comprise a couple of thumbs-up/thumbs-down buttons displayed near, over, along side or in any other position or grades of transparency, such that their association with, or relevance to a specific content and/or advertisements is clear. According to embodiments of the invention, by pressing the thumbs-up button a user may indicate approval of the relevant content or advertisement. Accordingly, by pressing the thumbs-down button a user may indicate disapproval of the relevant content or advertisements. According to embodiments of the invention, clicking on such thumbs-up or thumbs-down may cause code embedded in the advertisement to communicate a selection parameter indicating the user approval or disapproval of a specific content to a selection parameters server, e.g., selection parameters server 105. According to embodiments of the invention, communication of such parameters may further include communicating the identification parameter, e.g., a cookie stored on a user's computer as described above. According to embodiments of the invention, communicating the identification parameter may enable a selection parameter server to associate the selection preferences with a specific user or computer. Selection parameters received by a selection server may be stored, possibly in addition to already stored parameters, with association to the accompanying identification parameter, e.g. a cookie. According to embodiments of the invention, stored selection parameters may be located and used for a selection of content and/or advertisements, possibly by utilizing a received associated identification parameter. For example as described above with reference to FIG. 3.

According to embodiments of the invention, an advertisement may comprise a menu, a pull-down menu, a popup object or any other form or type of graphical or other user interface enabling a user to select, configure or otherwise manipulate various options and/or parameters pertaining to serving and/or providing of content and/or advertisement, e.g., opt-in or opt-out. For example, aspects according to which content and/or advertisements may be opt-in or opt-out or otherwise configured may be the type of the advertisements, the source of the advertisement, the internet site associated with the advertisement or any other applicable aspects pertaining to the advertisement or relevant content. For example, a user may opt-out a specific type of advertisements, possibly from a specific site, e.g., advertisements for banking services from a site or publisher of online games. Another example for opt-out may be not to display content from a specific publisher, or while viewing a website of a particular publisher, irrespective of content type or advertiser. Another example of a possible interaction method may be a pull down menu that may be associated with content presented to a user, where such pull down menu may provide a user with various feedback options, e.g. “block content of this type”, “provide more content of this type”, “don't present such content from 09:00 to 17:00” or “don't display such content in association with this site”.

According to embodiments of the invention, selection parameters may be stored on a user's computer. For example, selection parameters may be stored on computer 141. Accordingly, such selection parameters may be communicated to an advertisement server, for example over a session established as shown by block 315 in FIG. 3. Accordingly, an advertisement server such as server 303 may perform content and/or advertisement selection based on such parameters. According to embodiments of the invention, selection parameters may be embedded in a cookie. For example, having been provided with, or having otherwise obtained selection parameters as shown by block 340, an advertisement server such as server 303 may create a cookie, embed or otherwise incorporate the selection parameters in the cookie and further cause such cookie to be installed on a user's computer. According to embodiments of the invention, the advertisement server may retrieve such cookie over a consequent session, extract the selection parameters from the cookie and use the selection parameters in order to select content and/or advertisements to be provided to the user.

According to embodiments of the invention, content presented to the user such as in block 350 of FIG. 3, may contain or include an advertiser survey or questionnaire. For example, advertiser 125 may conduct a customer satisfaction survey on behalf of a company. According to embodiments of the invention, a customer of the company, user 141, may interact with the questionnaire content and provide selection parameters associated with the questionnaire content, such as in block 325 or block 225. Although not shown in drawings, it will be recognized that in some embodiment of the invention, the advertisement server 130 may communicate to the company conducting the survey information pertaining to survey content presented to user, and user content communicated to the advertiser in response to or interaction with survey content.

It will be recognized that while various embodiments of the invention have been described herein, other embodiments are possible. For example, an embodiment has been described herein in which the interaction of the user with the content to obtain content selection parameters may be in a presented content item of advertisement, for example, by a user clicking on or rolling over words, a link, or an icon. In some embodiments of the invention, these interactive elements may be part of an advertisement presented by an advertiser or an advertisement server, in which case, the user's selection parameters may be gathered by the advertiser or advertisement server and provided to a central repository. In another embodiment of the invention, the portions of the display for interaction of the user with the content to obtain content selection parameters may be, adjacent or proximate the displayed advertisement, and the selection parameters may be gathered by the publisher on whose web site the words, link, or icon for entering selection parameters are presented. In this case, the publisher may be responsible for forwarding the user's selection parameter preferences to a central repository. In both cases, instead of forwarding information to a central repository, interaction with the content may initiate an application to communicate the selection parameters directly to a selection parameter server, as described herein. Other variations are possible within the scope of the invention.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for providing content comprising:
presenting a content item to a user;
obtaining a plurality of selection parameters from said user;
selecting a subsequent content item to be provided to said user based at least in part on said obtained selection parameters; and
presenting said subsequent content item to said user.

2. The method of claim 1,
wherein said content item is presented in a communication session, and
wherein the subsequent content item is presented in a subsequent communication session, subsequent to said communication session.

3. The method of claim 2, wherein said plurality of selection parameters are obtained by an interaction of said user with said presented content item.

4. The method of claim 3, further comprising:
storing at least some of said plurality of selection parameters on a computing device; and
communicating at least some of said plurality of selection parameters to a content selection computer,
wherein selecting said subsequent content item comprises selecting said subsequent content item by said content selection computer based at least in part on said communicated selection parameters.

5. The method of claim 4, further comprising:
obtaining an identification parameter from said user; and
storing an association between at least some of said plurality of selection parameters and said identification parameter on said content selection computer, wherein
wherein selecting said subsequent content item comprises selecting said subsequent content item based, at least in part, on selection parameters associated with said identification parameter.

6. The method of claim 4, wherein said content comprises a content type selected from the group consisting of: advertising content, a questionnaire survey, and a user-entry survey.

7. The method of claim 4, wherein said receiving of a plurality of selection parameters is performed during a presentation of content to said user and wherein at least some of said plurality of selection parameters are associated with said presented content.

8. The method of claim 7, wherein said content comprises advertising content.

9. The method of claim 4, wherein said plurality of selection parameters are associated with said user.

10. The method of claim 4, wherein said plurality of selection parameters are associated with said computing device.

11. The method of claim 4, wherein at least some of said plurality of selection parameters comprise a restriction on providing a content type.

12. The method of claim 4, wherein at least some of said plurality of selection parameters indicate a lack of interest by a user in presented content.

13. The method of claim 4, wherein at least some of said plurality of selection parameters indicate approval or disapproval by a user of a content property selected from the group consisting of: presented content type, at least one content keyword, an advertiser, a publisher, a time of day, and a day of the week.

14. A system comprising:
an advertisement selection computer capable of communicating over a network with a customer computer, wherein in a first session said advertisement selection computer is to:
receive an identification parameter relating to a user operating said customer computer,
receive from said customer computer a plurality of content selection parameters,
store an association between said identification parameter and said plurality of content selection parameters, and
wherein in a second session, subsequent to said first session, said advertisement selection computer is to:
receive said identification parameter,
based on at least some of said plurality of content selection parameters, select at least one content object, and
cause to be provided to said customer computer said at least one content object.

15. The system of claim 14, wherein said advertisement selection computer is further to:
store information pertaining to said customer computer, and
select said at least one content object based at least in part on said information associated with said customer computer.

16. The system of claim 14, wherein said advertisement selection computer is further to:
cause said customer computer to store information pertaining to said selection parameters and,
select said at least one content object based at least in part on said information associated with said information stored on the customer computer.

17. The system of claim 14, wherein said advertisement selection computer is capable of communicating over a network with said customer computer, and wherein said advertisement selection computer is further to:
cause said customer computer to communicate said selection parameters to said advertisement selection computer over said network.

18. The system of claim 14, wherein said plurality of content selection parameters indicate a lack of interest by a user in presented content.

19. The system of claim 14, wherein at least some of said plurality of selection parameters comprise a restriction on providing a specific content type.

20. The system of claim 14, wherein at least some of said plurality of selection parameters indicate a lack of interest by a user in presented content.

21. The system of claim 14, wherein at least some of said plurality of selection parameters indicate approval or disapproval by a user of a content property selected from the group consisting of: presented content type, an advertiser, a publisher, a time of day, and a day of the week.

22. The system of claim 14, wherein said identification parameter is a cookie.

23. The system of claim 14, wherein said content comprises advertising content.

24. The system of claim 14, wherein said plurality of selection parameters are associated with said user.

25. The system of claim 14, wherein said plurality of selection parameters are associated with said user.

26. The system of claim 14, wherein said plurality of selection parameters indicate a computing device associated with said user.
